(19) United States
(12) Patent Application Publication
(10) Pub. No.: US 2007/0187936 A1
(43) Pub. Date: Aug. 16, 2007

(54) Impact protection device for a vehicle occupant

(75) Inventor: Thomas Britz, Bessenbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/704,653

(22) Filed: Feb. 9, 2007

(30) Foreign Application Priority Data
Feb. 13, 2006 (DE) 20 2006 002 253.8

(51) Int. Cl. B60R 21/239

(52) U.S. Cl. 280/739; 280/743.1; 280/743.2

(57) ABSTRACT

An impact protection device for a vehicle occupant includes a gas bag, a tension means (16) and a drawing arrangement (22). The gas bag has at least one discharge opening (12). The cross section of the discharge opening (12) is able to be altered by means of the tension means. The tension means is coupled to the drawing arrangement which is not fastened to the gas bag.

### TECHNICAL FIELD

The invention relates to an impact protection device for a vehicle occupant.

### BACKGROUND OF THE INVENTION

An impact protection device with a gas bag which has at least one discharge opening, the cross-section of which is able to be altered by means of a tension means which is coupled to a drawing arrangement is known from EP 0 917 994 A. With this device, a discharge opening can be reduced in size by means of a non-elastic thread which is arranged on the fabric surface of the gas bag and is guided in a loop crosswise around the discharge opening. The outer portions of the thread are guided over expanding regions of the gas bag, and the ends of the thread are fastened on the surface of the gas bag. Thus, as a result of the internal pressure which is produced when a vehicle occupant plunges into the gas bag, a reduction of the cross-section of the discharge opening is achieved which is proportional to the elastic expansion of the gas bag.

It is an object of the invention to provide an impact protection device with a gas bag, the discharge behaviour of which is individually adjustable by simple means.

### SUMMARY OF THE INVENTION

In accordance with the invention, an impact protection device comprises a gas bag, a tension means and a drawing arrangement. The gas bag has at least one discharge opening. The cross section of the discharge opening is being able to be altered by the tension means. The tension means is coupled to the drawing arrangement which is not fastened to the gas bag. The invention is based on the finding that, in particular cases, a reduction of the discharge cross-section is advantageous which is different from a reduction which is dependent on the on the expansion of the gas bag. The impact protection device according to the invention makes possible a controlling of the discharge cross-section which is independent of the expansion. Therefore, after an analysis of the actual case of load, the discharge cross-section can be accordingly adjusted or even varied over time, if necessary with the inclusion of several relevant parameters such as the body weight of the vehicle occupant, severity of impact, type of impact etc.

In the preferred embodiment of the invention, the tension means has two ends. The first end is connected with the drawing arrangement, and the second end is connected with a fixed component. Alternatively, however, provision may also be made that both ends are connected with a drawing arrangement. In the latter case, the ends of the tension means may either be connected with different drawing arrangements or, with a suitable deflection of the tension means, they may be connected with the same drawing arrangement.

An electronic control unit which evaluates the relevant parameters of the case of load and causes a corresponding activation of the drawing arrangement is preferably provided for controlling the drawing arrangement.

According to the preferred embodiment, the drawing device comprises a movable component to which one end of the tension means is coupled. The control unit is able to initiate a movement of the component. To increase the “efficiency” of the drawing arrangement, a gear ratio can be provided, acting between the tension means and the movable component.

A movement of the component preferably takes place against the resistance of at least one spring element which prestresses the component into an initial position.

An electromagnet, which can exert an attractive force onto the component, may be provided, for example, for controlling the movement of the component.

According to a particular aspect of the invention, the impact protection device has a control mechanism coupled to the tension means for altering the cross-section of the discharge opening. The control mechanism is designed so that a drawing on the tension means causes the cross-section to increase in size. This type of construction is suitable for a gas bag which is designed to be relatively hard, i.e. which has a high internal pressure after inflation, in order to provide a sufficient restraining effect for a heavy vehicle occupant, in particular in the case of a heavy impact. In the case of a light vehicle occupant or a less intense impact, the control mechanism can increase the size of the discharge opening in order to adapt the internal pressure of the gas bag accordingly.

A possible realization of such a control mechanism according to the invention provides a scissor-like element with two rigid arms. The arms are coupled to each other by means of a swivel joint and at least partially surround the discharge opening. Pulling the arms apart brings about an enlargement of the discharge opening.

### BRIEF DESCRIPTION OF THE DRAWINGS

FIG. 1a discharge opening in a gas bag with an alterable cross-section according to a first embodiment of the invention;

FIG. 2 a drawing device; and

FIG. 3 a control mechanism to alter the cross-section of a discharge opening in a gas bag according to a second embodiment of the invention.

### DETAILED DESCRIPTION OF THE PREFERRED EMBODIMENTS

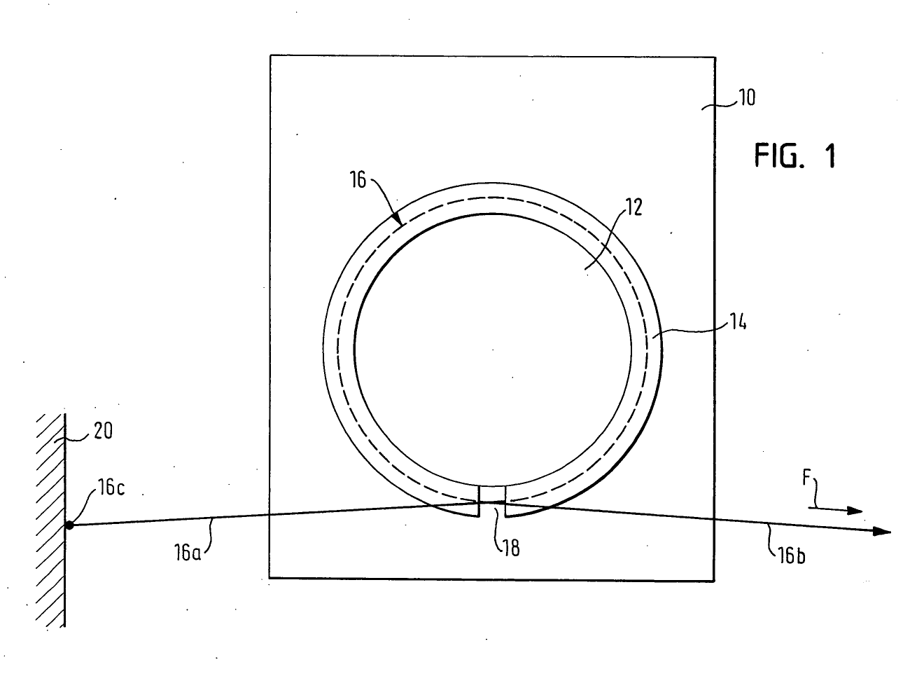

In FIG. 1 a portion of a gas bag surface 10 with a discharge opening 12 is shown. A pocket 14 is provided, encircling almost completely on the edge of the discharge opening 12. The pocket 14 may be formed, for example, by marginal sections of the gas bag material being folded over outwards in the manner of a loop and sewn on the edge on the discharge opening 12. In this way, a portion of the gas bag fabric, which would otherwise be removed to provide the discharge opening 12, can be utilized in an efficient and cost-saving manner.

A tension means 16 in the form of a tear-resistant non-elastic thread or wire is guided in the pocket 14 around the discharge opening 12, the end sections 16a, 16b crossing over each other in an outlet region 18 outside the pocket 14. Inside the pocket 14, the tension means 16 is fastened to the gas bag at several points which are spaced apart from each other in the peripheral direction. The fastening may take place, for example, by partially sewing on or by sticking fast at points. The crossed-over end sections 16a, 16b are not fastened to the gas bag and run in opposite directions. Whereas one end 16c of the tension means 16 is anchored to a fixed component 20, e.g. a gas bag module component, a drawing arrangement 22 (not illustrated in FIG. 1) engages on the other end 16d.

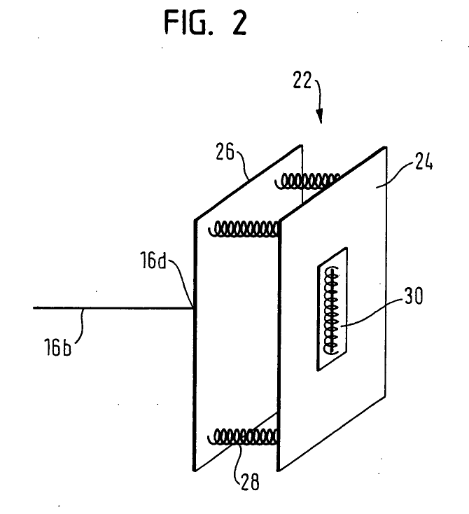

A possible embodiment of the drawing arrangement 22 is shown in FIG. 2. A stationary plate 24 and a movable plate 26 are arranged at a distance from each other which is preset by several compressible springs 28 (initial position). The end 16d of the tension means 16 is connected with the movable plate 26 which consists of a magnetizable material. An electromagnet 30 is arranged on the stationary plate 24 so that it can exert an attractive force onto the movable plate 26. The current supply of the electromagnet 30 takes place by means of an electronic control unit (not illustrated).

The electronic control unit initially provides for a “base current” to flow through the electromagnet 30, which is measured such that the attractive force acting on the movable plate 26 corresponds exactly to the restoring force of the springs 28. In a case of restraint, the attraction can be intensified by increasing the flow of current, and thereby a movement of the plate 26 can be brought about from its initial position against the resistance of the springs 28 towards the stationary plate 24. Owing to the provision of the base current of the electromagnet 30, the movement of the plate 26 takes place immediately, because no initial resistance has to be overcome. The movement of the plate 26 corresponds to a drawing at the end 16d of the tension means 16, which leads to a constriction of the discharge opening 12. Owing to the fastening points which are spaced apart in the peripheral direction, the gas bag fabric can be gathered up in the marginal region of the discharge opening 12.

The procedure for constricting the discharge opening can be accelerated by a suitable gear ratio (e.g. in the manner of a reversed pulley) being provided between the tension means 16 and the movable plate 26. Another possibility is pulling also on the end 16c of the tension means 16. For this, the end 16c may be coupled to a further drawing arrangement or, with a suitable deflection of the end section 16a, to the same drawing arrangement 22.

In each case, the electronic control unit provides for a particular tension to be exerted on the tension means 16, depending on the impact data supplied to the control unit, in order to affect the cross-section of the discharge opening 12 in line with a specific aim.

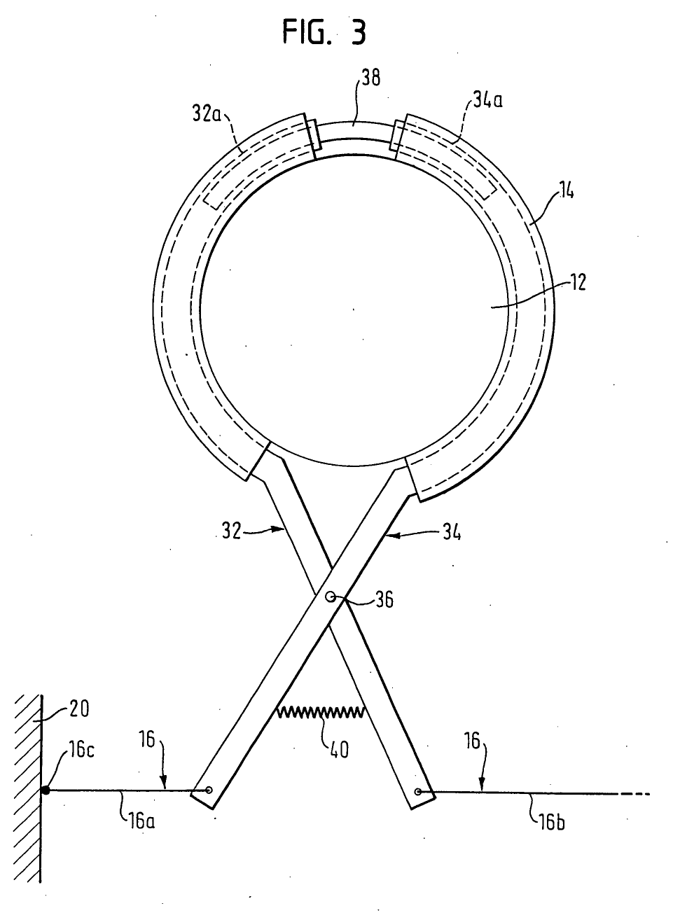

A special control mechanism to alter the cross-section of the discharge opening 12 is illustrated in FIG. 3. In contrast to the embodiment which was described above, this control mechanism makes possible an enlargement of the cross-section of the discharge opening 12 in line with a specific aim. Here, the pocket 14 is interrupted at least two points in the peripheral direction. Arms 32, 34 of a rigid material, which are adapted to the shape of the discharge opening 12, are inserted into the two pocket parts. The arms 32, 34 are part of a control element, constructed in the manner of scissors, which has a swivel joint 36 connecting the arms 32, 34.

On the side of the discharge opening 12, the end sections 32a, 34a of the arms 32, 34 each have a hollow profile. An intermediate piece 38 of flexible material can be introduced through the interruption in the pocket 14 into the hollow end sections 32a, 34a of the arms 32, 34, and can be fastened there. The intermediate piece 38 is either extensible, or a guide is provided in one of the arms 32, 34, within which the intermediate piece 38 can move.

On the side of the swivel joint 36 facing away from the discharge opening 12, at least one arm end is connected with a tension means 16 which is, in turn, coupled to a drawing arrangement 22 (not illustrated in FIG. 3). The corresponding end of the other arm may be securely mounted or may be fastened with a further tension means 16 on a fixed component 20, or may likewise be coupled to a drawing arrangement. A tension spring 40 is provided between the two arms 32, 34, which prestresses the control element into an initial position. In the initial position, the gas bag fabric is gathered around the discharge opening 12.

A pulling apart of the arm sections, connected with the tension means, contrary to the prestressing force of the spring 40 causes the arm sections 32a, 34a to move apart like scissors on the other side of the swivel joint 36, so that the discharge opening 12 is enlarged. Owing to the gathering of the gas bag fabric around the discharge opening 12, the enlargement is not impeded by the gas bag fabric.

1. An impact protection device for a vehicle occupant, the impact protection device comprising a gas bag, a tension means and a drawing arrangement, the gas bag having at least one discharge opening, the cross-section of the discharge opening being able to be altered by the tension means, the tension means being coupled to the drawing arrangement which is not fastened to the gas bag.

2. The impact protection device according to claim 1, wherein the tension means has two ends, one end being connected with the drawing arrangement and the other end being connected with a fixed component.

3. The impact protection device according to claim 1, wherein the tension means has two ends, the two ends being connected with a drawing arrangement.

4. The impact protection device according to claim 1, wherein the tension means is securely connected with the gas bag in a margin region of the discharge opening.

5. The impact protection device according to claim 1, wherein an electronic control unit is provided for controlling the drawing arrangement.

6. The impact protection device according to claim 5, wherein the drawing arrangement comprises a movable component to which one end of the tension means is coupled, and wherein the control unit can initiate a movement of the component.

7. The impact protection device according to claim 6, wherein a gear ratio acts between the tension means and the movable component.

8. The impact protection device according to claim 6, wherein a movement of the component takes place against the resistance of at least one spring element which prestresses the component into an initial position.

9. The impact protection device according to claim 6, wherein an electromagnet is provided for controlling the movement of the component.

10. The impact protection device according to claim 1, wherein a control mechanism is coupled to the tension means for altering the cross-section of the discharge opening, the control mechanism being designed so that a drawing on the tension means causes an enlargement of the cross-section of the discharge opening.

11. The impact protection device according to claim 10, wherein the control mechanism has a scissor-like element with two rigid arms coupled to each other by means of a swivel joint, the arms at least partially surround the discharge opening.

12. The impact protection device according to claim 11, wherein due to prestressing, the arms assume an initial position.

13. The impact protection device according to claim 11, wherein an elastic intermediate piece connects one end of one of the arms with one end of the other arm.
